(19) United States
(12) Patent Application Publication
(10) Pub. No.: US 2012/0066650 A1
(43) Pub. Date: Mar. 15, 2012

(54) Electronic Device and Method for Evaluating the Strength of a Gestural Password

(75) Inventors: Thomas M. Tirpak, Glenview, IL (US); Larry D. Svec, Wauconda, IL (US)

(73) Assignee: MOTOROLA, INC., Schaumburg, IL (US)

(21) Appl. No.: 12/879,554

(22) Filed: Sep. 10, 2010

(51) Int. Cl. G06F 3/033

(52) U.S. Cl. 715/863

(57) ABSTRACT

An electronic device includes a movement sensing assembly for providing signals indicative of movement of an object with respect to the electronic device, wherein the movement includes a sequence of gestures making up a proposed gestural password. A processor in electronic communication with the movement sensing assembly is operable to receive and evaluate the signals to compute a password strength metric indicative of a strength of the proposed gestural password, and a user output component receives and displays an acceptability of the password strength metric.

### FIELD OF THE INVENTION

The present invention relates to an electronic device and corresponding method for evaluating the strength of a gestural password that includes a sequence of gestures, and optionally providing recommendations for improving the strength of the gestural password.

### BACKGROUND

Electronic devices such as mobile phones, smart phones, and other handheld or portable electronic devices such as personal digital assistants (PDAs), audio players, headsets, etc. have become popular and ubiquitous. More and more features have been added to these devices, and they are often equipped with various user input components for communicating instructions to control operation of the electronic device. For example, many mobile devices are equipped not only with various buttons and/or keypads, but also with touch detecting surfaces (such as touch screens or touch pads) by which a user, simply by touching a particular area of the mobile device and/or by moving a finger along the surface of the mobile device, is able to communicate instructions to control the electronic device.

It is often desirable to have password protection to prevent unauthorized usage of an electronic device. Recently, gestural passwords have been utilized in conjunction with touch detecting surfaces in order to “unlock” corresponding electronic devices, or to provide access to a particular application or account via the electronic device. A gestural password simplifies an authorization process by avoiding the need to input alphanumeric text via a keypad. For example as shown in each of FIGS. 1-3, graphical patterns 100, 200, 300 on the touch detecting surface can be formed by a sequence of strokes (also called glide gestures) of a user's finger, and these gestural passwords operate to allow subsequent use of the electronic device. In some cases, such as illustrated in FIG. 3, the sequence of strokes can occur between points 302 of a predefined grid. However, over time, these stroke sequences can leave corresponding smear patterns 400, 500, 600 on a touch detecting surface, as illustrated in FIGS. 4-6, and this can be a security risk, in that a smear pattern can provide others with information to guess the password. In this regard, the use of a gestural password at a public electronic device can be especially problematic. Regularly cleaning the surface can prevent this inadvertent disclosure of information, but such cleaning is time-consuming and can require special materials that may not always be readily available. Further, a gestural password can sometimes be ascertained by a person by merely watching a user input the gestural password to a corresponding device.

Previously there has not been a system or method for evaluating the strength of gestural passwords or for automatically providing recommendations for improving the strength of such passwords. Thus, it is desirable to provide systems and methods to do so such that the gestural password cannot be easily determined by looking at a smear pattern on a touch detecting surface, and cannot be easily determined simply by watching a user input the password. Further, rules can be implemented and recommendations can be provided such that the gestural password simply provides a more reliable way for an authorized user to unlock a corresponding electronic device or have access to an account or application via the electronic device.

### BRIEF DESCRIPTION OF THE DRAWINGS

FIGS. 1-3 are examples of patterns on a touch detecting surface formed by a user's finger over a predefined grid;

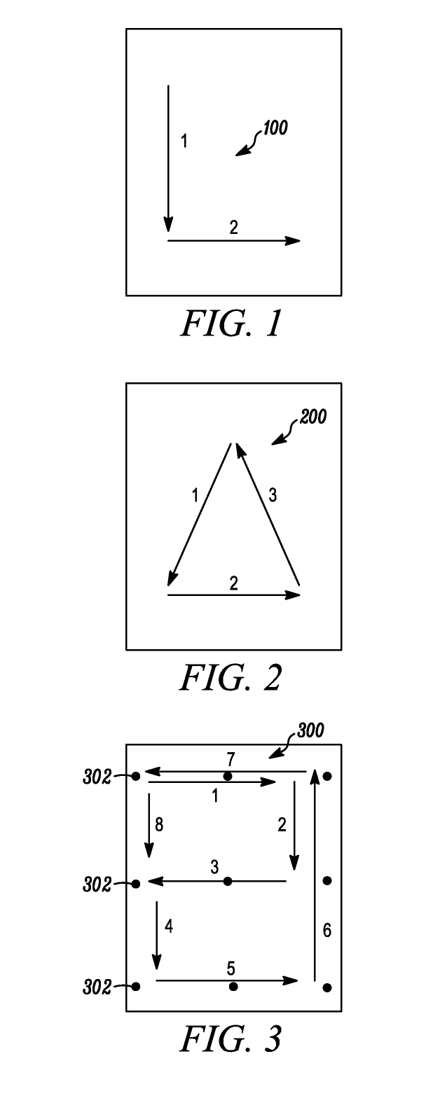

FIGS. 4-6 are examples of corresponding smear patterns on the touch detecting surface;

FIG. 7 is an exemplary electronic device;

FIG. 8 is a block diagram of the exemplary electronic device of FIG. 7; and

FIG. 9 is a flowchart showing exemplary steps of a method that can be performed by the electronic device of FIG. 7.

### DETAILED DESCRIPTION

An electronic device with a processor and one or more movement sensing assemblies such as touch detecting surfaces can be configured to be operable with a predetermined gestural password that is a sequence of gestures drawn by a user's finger (or other object), with the movement sensing assembly operating to detect the gestural password. A user can input a proposed gestural password to the electronic device, and the electronic device can operate to detect and analyze the proposed gestural password, and provide a metric indicative of the strength of the proposed gestural password. As used herein, the strength can encompass a reliability of the gestural password as well. The strength metric can be computed by analyzing such items as the complexity of the gestural password, the size of the gestural password, the trace uniqueness of the gestural password, and the anticipated reliability of the gestural password, as well as various other factors. Suggestions for increasing the strength and/or reliability of the gestural password can also be provided, allowing for a user to increase the security associated with a corresponding electronic device.

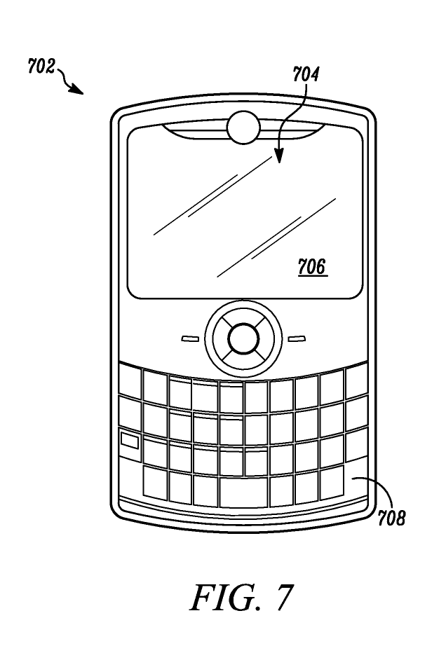

An exemplary electronic device 702 including a movement sensing assembly such as a touch detecting surface 704 is shown in FIG. 7, and this device is operable to receive a proposed gestural password to be analyzed. The exemplary electronic device 702 is shown as a mobile smart phone, and can include functions such as calling, emailing, texting, and internet browsing functions, as well as others. In other embodiments, the device can be one of a variety of other electronic devices such as a personal digital assistant, an audio and/or video player, a headset, a navigation device, a notebook, laptop or other computing device, or any other device that can utilize or benefit from use of a gestural password and an analysis of the gestural password. Further, the motion detection assembly can take other forms such as a sensing assembly having a plurality of sensing devices, such as shown and described in U.S. patent application Ser. No. 12/471,062, titled “Sensing Assembly For Mobile Device” and filed on May 22, 2009, which is hereby incorporated by reference. For example, this sensing assembly can include several phototransmitters arranged to emit light outwardly in various directions, with at least one photoreceiver arranged to receive respective portions of transmitted light originating from each phototransmitter that has been reflected off an object. Such a sensing assembly can be operable to detect a three-dimensional gestural password, rather than just a two-dimensional gestural password as is detectable by the touch detecting surface 704.

The touch detecting surface 704 can be in the form of a touch screen or a touch pad for example, and can be any of a variety of known touch detecting technologies such as a resistive technology, a capacitive technology, or an optical technology. As illustrated, the touch detecting surface 704 includes a light permeable panel or other technology which overlaps a display screen 706 (such as a liquid crystal display screen) to create a touch screen on all or a portion of the display screen 706, and a keypad 708 having numerous keys for inputting various user commands for operation of the device. A touch screen is advantageous because graphics can be displayed directly underlying the touch detecting surface on which controlling touch gestures are applied. In one embodiment, an array of grid points (see FIG. 3) can be displayed on the display screen to provide a grid over which a two-dimensional gestural password can be input by a user as a sequence of strokes (glide gestures), although in other embodiments, such a grid need not be provided, and a password can be input for example in a particular area on the display screen.

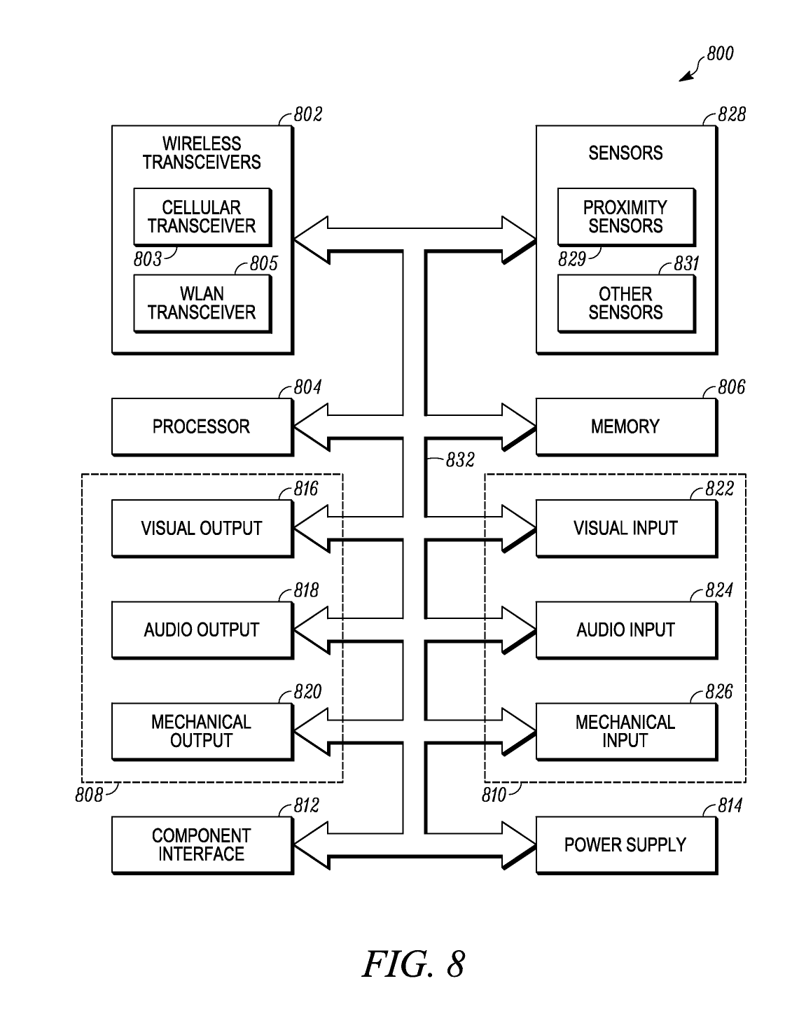

Referring to FIG. 8, a block diagram 800 illustrates exemplary internal components of the mobile smart phone implementation of the electronic device 702. These components can include wireless transceivers 802, a processor 804 (e.g., a microprocessor, microcomputer, application-specific integrated circuit, or the like), memory 806, one or more output components 808, one or more input components 810, and one or more sensors 828. The device can also include a component interface 812 to provide a direct connection to auxiliary components or accessories for additional or enhanced functionality, and a power supply 814, such as a battery, for providing power to the other internal components. All of the internal components can be coupled to one another, and in communication with one another, by way of one or more internal communication links 832 such as an internal bus.

More specifically, the wireless transceivers 802 can include both cellular transceivers 803 and a wireless local area network (WLAN) transceiver 805. Each of the wireless transceivers 802 utilizes a wireless technology for communication, such as cellular-based communication technologies including analog communications (using AMPS), digital communications (using CDMA, TDMA, GSM, iDEN, GPRS, EDGE, etc.), and next generation communications (using UMTS, WCDMA, LTE, IEEE 802.16, etc.) or variants thereof, or peer-to-peer or ad hoc communication technologies such as HomeRF, Bluetooth and IEEE 802.11 (a, b, g or n), or other wireless communication technologies.

The memory 806 can encompass one or more memory devices of any of a variety of forms (e.g., read-only memory, random access memory, static random access memory, dynamic random access memory, etc.), and can be used by the processor 804 to store and retrieve data. The data that is stored by the memory 806 can include operating systems, applications, and informational data. Each operating system includes executable code that controls basic functions of the electronic device, such as interaction among the various internal components, communication with external devices via the wireless transceivers 802 and/or the component interface 812, and storage and retrieval of applications and data to and from the memory 806. Each application includes executable code that utilizes an operating system to provide more specific functionality for the communication devices, such as file system service and handling of protected and unprotected data stored in the memory 806. Informational data is non-executable code or information that can be referenced and/or manipulated by an operating system or application for performing functions of the communication device.

Exemplary operation of the wireless transceivers 802 in conjunction with others of the internal components of the electronic device 702 can take a variety of forms and can include, for example, operation in which, upon reception of wireless signals, the internal components detect communication signals and the transceiver 802 demodulates the communication signals to recover incoming information, such as voice and/or data, transmitted by the wireless signals. After receiving the incoming information from the transceiver 802, the processor 804 formats the incoming information for the one or more output components 808. Likewise, for transmission of wireless signals, the processor 804 formats outgoing information, which may or may not be activated by the input components 810, and conveys the outgoing information to one or more of the wireless transceivers 802 for modulation as communication signals. The wireless transceiver(s) 802 convey the modulated signals to a remote device, such as a cell tower or an access point (not shown).

The output components 808 can include a variety of visual, audio, and/or mechanical outputs. For example, the output components 808 can include one or more visual output components 816 including the display screen 706. One or more audio output components 818 can include a speaker, alarm, and/or buzzer, and a mechanical output component 820 can include a vibrating mechanism for example. Similarly, the input components 810 can include one or more visual input components 822 such as an optical sensor of a camera, an audio input component 824 such as a microphone, and a mechanical input component 826. In particular, the mechanical input component 826 can include, among other things, the touch detecting surface 704, and the keypad 708 of FIG. 7. Actions that can actuate one or more input components 810 can include for example, opening the electronic device, unlocking the device, moving the device, and operating the device.

The sensors 828 can include both proximity sensors 829 and other sensors 831, such as an accelerometer, a gyroscope, or any other sensor that can provide pertinent information, such as to identify a current location or orientation of the device 702.

The electronic device 702 is operable in various modes. In a password construction mode, the processor 804 can analyze a proposed gestural password, can determine whether the proposed gestural password meets acceptable strength and/or reliability standards, can provide suggestions to improve the strength and/or reliability, and can prompt a user to input a new proposed gestural password if a first one is unacceptable. In a password recognition mode, the processor 804 can determine whether an applied gestural password matches a predetermined stored gestural password in order to unlock the electronic device or provide access to one or more applications or accounts via the electronic device.

A gestural password can be applied by way of touching the touch detecting surface 704 by various means, including but not limited to using a finger (including a thumb), fingernail, hand or portion thereof, or a stylus device. In some embodiments, the touch detecting surface 704 can be activated by way of other types of actions, such as by swiping, pinching, and applying pressure, which actions are all considered touches. However, the touch detecting surface 704 may or may not be capable of distinguishing between different pressures or forces of touches. Further, as used herein, a tap gesture occurs when a finger or other object remains in contact with the touch detecting surface generally at a single location, for a predetermined amount of time and then lifts off. A glide gesture occurs when a finger or other object remains in contact with the touch detecting surface and is moved along the touch detecting surface. Other gestures, including gestures unique to three-dimensional space, can be defined and used in accordance with the teachings of this document.

The touch detecting surface 704 provides signals via link 832 to the processor 804 indicative of applied gestural passwords made up of one or more component touch gestures. The processor monitors output signals from the touch detecting surface 704 and, in conjunction therewith, can determine characteristics associated with each individual component touch gesture, including relative locations (e.g., coordinates) of each on the touch detecting surface 704 at various points in time and can detect properly applied gestural passwords.

For example, the component touch gestures making up a gestural password can be a sequence of consecutively applied glide gestures, where each glide gesture is essentially a line segment (which may or may not be applied over a corresponding grid). The gestural password can also include other component gestures such as one or more tap gestures, which are mere touches on the touch detecting surface. The processor 804 can be programmed to detect the individual glide gestures and determine various characteristics of the individual glide gestures, including for example the number of component glide gestures making up the gestural password, coordinates corresponding to a beginning point and an end point of each applied glide gesture (the beginning and end points referred to as nodes), a nearest grid point corresponding to each node (if applicable), a relative location of a node of one glide gesture with respect to a node of another glide gesture, whether there is a gap between each pair of consecutive glide gestures (i.e., where contact between a user's finger and the touch detecting surface is broken), a movement amount (e.g., a touch distance), a direction, a speed, and/or a duration of a glide gesture. Further, a location of the occurrence of any tap gestures can be determined. These characteristics can be used both in an analysis of a proposed gestural password, and in a determination of whether an applied gestural password matches a predetermined stored gestural password.

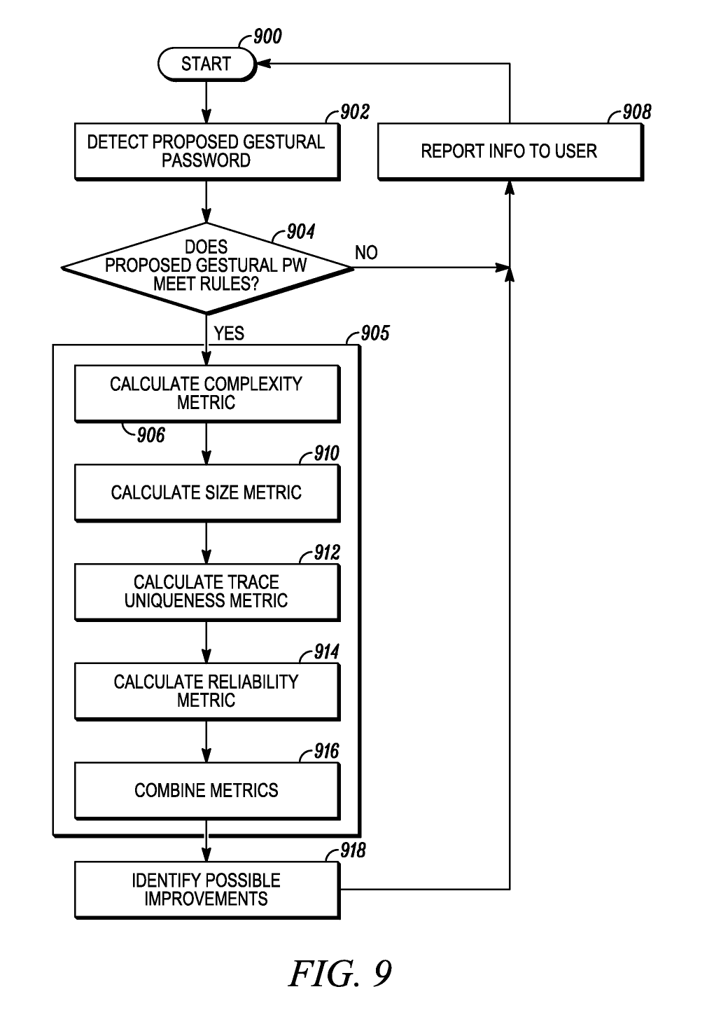

In particular, the electronic device 702 and processor 804 can be programmed to perform a method such as the exemplary method depicted in FIG. 9. The method starts at a step 900 when the electronic device is in the password construction mode, in which the processor monitors signals from the touch detecting surface 704. A user can then input a proposed gestural password as a sequence of gestures, including for example one or more glide gestures, where each glide gesture begins and ends at corresponding nodes, and/or one or more tap gestures, where each occurs at a corresponding node. As mentioned, in some cases the proposed gestural password can be constrained such that the nodes should correspond to a corresponding grid point of a grid which can be displayed on the display screen. In some cases, the gestural password can include a sequence of gestures with each gesture separated by a predefined act, such as a gap between gestures, for example caused by a finger lift between an ending point of one gesture and the starting point of a subsequent gesture. Another predefined act can be a pause between gestures, for example caused by a finger remaining at the ending point of one gesture for a predetermined amount of time prior to beginning another gesture.

Various other types of gestural passwords composed of a sequence of gestures can also be defined. For example, a user can input each of the component gestures of a proposed password, along with a corresponding recognition policy for each individual gesture. In this manner, a gestural password and any corresponding smear pattern can be made more complex, which can make it more difficult for someone viewing a user entering such a gestural password to remember and replicate the password, while minimizing the authorized user's cognitive complexity to remember and input the password correctly. In this case, the password recognition mode utilizes knowledge of the stored gestural password, its component gestures, and corresponding recognition policies for each of the component gestures to determine if a user has correctly input a gestural password.

In particular, a recognition policy can be selected from a group such as one including the following: (a) match, (b) not match, (c) ignore, and (d) match one in a set. In the case of a recognition policy that is specified as “match”, a gesture input by a user which corresponds to a specific slot in the sequence must match a stored gesture corresponding to that slot. For a recognition policy that is specified as “not match”, a gesture input by a user which corresponds to a specific slot in the sequence must not match any of the last N (a specified number) inputted gestures corresponding to that slot. For a recognition policy that is specified as “ignore”, a gesture input by a user which corresponds to a specific slot in the sequence can be anything, and will simply be treated as a “throw away” element, having a purpose to increase the apparent complexity of the gestural password. For a recognition policy that is specified as “match one of a set”, a gesture input by a user which corresponds to a specific slot in the sequence must match one of a defined set of gestures (the set having more than one gesture).

For example, using the (a)-(d) designations above, with the recognition policies for a gestural password that includes three component gestures as indicated below can be described as follows:

1. {(a), (a), (a)} In this case, all component gestures must match the corresponding stored gestures.
2. {(c), (a), (c)} In this case, the first and the third gestures are not evaluated, while the second gesture is evaluated and must match the corresponding stored gesture. In an open environment, where there is a risk of a gestural password input being observed, the user may decide to input complex first and third gestures. In an environment known to the user to be a secure one, the user may decide to input simply a tap gesture for each of the first and third gestures.
3. {(b), (a), (a)} In this case, the second and third gestures must match the corresponding stored gestures, but the first gesture must be different from that which was input for the last N attempts. This acts to thwart unauthorized replication of a gestural password which is observed or recorded on video camera.

Various schemes can be implemented during a password recognition mode using this type of password. For example, to facilitate password input by authorized users, the device may display a “hint” that identifies the recognition policies currently in effect, for example, “{(c), (a), (c)}”. In another embodiment, the device may additionally use environmental context information, for example, time of day, to randomize the recognition policies that will be put into effect. For example, during hours of the day which are multiples of the number two (2:00, 4:00, 6:00, etc.), recognition policy (a) is applied to the second, fourth, etc. gesture.

Referring back to FIG. 9, at a step 902, the electronic device 702 detects when a properly applied proposed gestural password is applied to the touch detecting surface 704, and records a list of two-dimensional coordinates {x, y} corresponding to the beginning and end points of each component glide gesture of the gestural password, records any gaps between gestures, and/or records a node point corresponding to any tap gesture of the gestural password. In other embodiments, three dimensional coordinates {x, y, z} can be recorded if for example the gestural password encompasses movements in three-dimensional space, such as can occur with other movement sensing assemblies. The time corresponding to each recorded coordinate pair can also be determined and recorded, along with any other corresponding characteristics mentioned above.

At a step 904, the processor determines whether a detected proposed gestural password complies with one or more predefined password rules or requirements. For example, this compliance process can involve the calculation of various metrics, as described with respect to steps 906, 910, 912, 914, 916 below. For example, a rule can require a proposed gestural password to include a minimum number and/or a maximum number of nodes, and/or to traverse a minimum number and/or a maximum number of grid points. Another password rule may require that a proposed gestural password form a pattern with a closed shape (or, alternately, an open shape).

For example, in a case wherein a minimum number of traversed grid points is required of a gestural password, the coordinates associated with the nodes of the glide gestures are analyzed and compared to the locations of the grid points to determine how many grid points have been traversed. Thus at step 904, the processor analyzes the data associated with a detected proposed gestural password to determine whether or not the proposed gestural password complies with the predefined rules.

If the proposed gestural password complies with the rules or requirements, then processing proceeds to a step 905, which comprises steps 906, 910, 912, 914, and 916. If not, processing then proceeds to a step 908, at which information regarding the non-compliance of the proposed gestural password is reported to the user via an output component such as the display screen 706. For example, the display screen 706 may state that the proposed gestural password is not acceptable. Identification of any rules that are not complied with can also be reported.

At step 905, the proposed gestural password is analyzed and a password strength metric is calculated, such as by calculating one or more component metrics. For example, at step 906, a complexity metric is calculated, wherein the following factors can be calculated and used to compute a complexity matrix: the number of nodes of the gestural password; the number of nodes plus two (or another value) times the number of repeated nodes; the number of nodes plus four (or another value) times the number of repeated edges (where an edge is a line segment defined by glide gesture); the number of nodes plus four (or another value) times the number of edges repeated at least three times; a number of gaps between edges of the proposed gestural password, as well as other variations of these concepts. Also, instead of nodes, the grid points of an underlying grid over which the gestural password is applied can also be used. In any case, the determined numbers for the above calculations can be separately used as input values for the complexity metric, or can be combined with each other with various predetermined scaling factors applied to calculate a value for the complexity metric. Processing then proceeds to a step 910.

At step 910, the proposed gestural password is analyzed, and a size metric is calculated. The size metric is indicative of the area or volume encompassed by application of the gestural password, and a smaller area or volume encompassed can be advantageous in that this can make it more difficult for someone observing the user inputting a password to figure out the password. In the case of an area, the width and height of the smallest rectangle that can enclose the gestural password can be determined by analyzing the nodes and/or grid points corresponding to the glide gestures making up the gestural password. In another embodiment, the sum of all edges of the gestural password can be determined. These can be accomplished as expressed below:

(Max{X}−Min{X})+(Max{Y}−Min{Y}) for all nodes i, or

Max{abs(x[i+1]−x[i])} for all nodes i, and Max{abs(y[i+1]−y[i])} for all nodes i, or

Sum of the length of all edges {(x[i],y[i]),(x[i+1],y[i+1])}.

Because each glide gesture is assumed to be linear, a nonlinear glide gesture can be reduced to a sequence of linear glide gestures for analysis or, alternately, a more complicated geometric algorithm can be used to calculate a size metric.

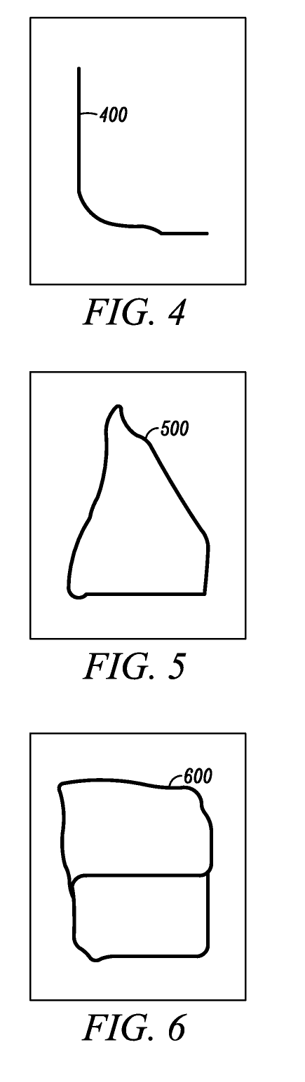

Processing then proceeds to a step 912. At step 912, the proposed gestural password is analyzed, and a trace uniqueness metric is calculated. The more unique a gestural password is, the more difficult it can be to guess, or to perhaps even to remember by an unauthorized observer trying to gain knowledge of the password. The trace uniqueness metric can be calculated using a combinatorial search algorithm to determine the number of unique sequences of nodes with which a smear pattern (see FIGS. 4-6) equivalent to that resulting from the input of the given gestural password may be applied to the touch detecting surface. Further, determination of this metric can include an analysis of whether the gestural password matches known simple shapes, symbols, or alphanumeric characters, such as in the language corresponding to the user. The user's language can be determined by querying user-specific interface settings on the device, or by analysis of media stored on the device. It can likewise be predicted by comparing location information, e.g., as may be ascertained from Global Positioning System (GPS) signals, to a reference database of the probability that a given language is spoken in the city, state, country, or other geographically defined area, where the device is located. In general, a password that includes one or more simple shapes, symbols, or alphanumeric characters is generally less unique, and correspondingly easier to guess, than one that does not. Further, this analysis can include a determination of whether the pattern traced by the gestural password is symmetrical, which is generally less unique than a non-symmetrical password.

The uniqueness analysis can also operate by identifying the number of closed regions in the gestural password (for example, there is one for the gestural password shown in FIG. 2, and two are shown in FIG. 3), determining the number of nodes forming each closed region, and multiplying these values together to determine a value, which can be combined with the factors above in an appropriate manner to compute the uniqueness metric. Processing then proceeds to a step 914.

Various other metrics can also be used to analyze the strength or the reliability of the proposed gestural password. For example, the use of an electronic device in different environmental conditions, including at different temperatures, can affect the operation of a touch detecting surface, and in order that an applied gestural password operate in a reliable manner, there may be certain characteristics that can improve reliability. At cold temperatures for example, certain detection surfaces may have more difficulty detecting gestures with the resulting effect that the applied glide gestures may be detected as having more gaps than are actually intended by a user, and to increase reliability it may be desirable to have a gestural password include few or no gaps between sequential glide gestures. Thus, at step 914, a reliability metric is calculated which takes into account the number of gaps between glides gestures making up the gestural password. Processing then proceeds to a step 916.

At step 916, the complexity metric, the size metric, the trace uniqueness metric, the reliability metric and any other metrics are combined to generate a password strength metric, such as by providing appropriate weighing factors to corresponding metrics, and then adding the results together to obtain a value for the password strength metric. In other embodiments, the password strength metric is computed using a single metric or various other combinations of these metrics. In some embodiments, a proposed gestural password having an associated password strength metric above a predetermined value (or below a predetermined value, depending on definition of the metric) can be acceptable as a password having an acceptable strength.

Processing then proceeds to a step 918, at which an improvement rules section of a database of the electronic device 702 is accessed, in order to identify a possible improvement tactic, if any, corresponding to the complexity, the size, the trace uniqueness and/or the reliability of the gestural password. For example, if any of the complexity metric, size metric, trace uniqueness metric, or reliability metric are below a predetermined value (or above a predetermined value, depending on definition of these metrics), then a corresponding specific suggestion can be generated, such as to increase a number of nodes or edges, to decrease the size, to increase the uniqueness, and/or to decrease the number of gaps of the proposed gestural password. Further, the processor can provide a suggested gestural password which can include one or more tap gestures, one or more glide gestures, and one or more delay requirements between corresponding component gestures.

Further suggestions can include adding one or more recognition policies corresponding to certain gestures of the gestural password, with the recognition policies including a match or a not match recognition policy. In the case that a strength is greater than a predetermined amount, but still less than an acceptable strength, other recognition policies can be added, such as a recognition policy to ignore one or more of the gestures of the gestural password, or a recognition policy to match one of a set of gestures.

Processing then proceeds to step 908, where the acceptability of the password strength metric, the password strength metric itself, and/or any determined improvement tactic is reported to a user via an output component of the electronic device.

Analyzing a proposed gestural password in such a manner prior to use can result in improved strength of a gestural password, and improved reliability and security for an electronic device.

It is specifically intended that the present invention not be limited to the embodiments and illustrations contained herein, but include modified forms of those embodiments, including portions of the embodiments and combinations of elements of different embodiments as come within the scope of the following claims.

We claim:

1. An electronic device comprising:
a movement sensing assembly for providing signals indicative of movement of an object with respect to the electronic device, wherein the movement includes a sequence of gestures making up a proposed gestural password;
a processor in electronic communication with the movement sensing assembly to receive and evaluate the signals to compute a password strength metric indicative of a strength of the proposed gestural password, and
a user output component to receive and communicate an acceptability of the password strength metric.

2. The electronic device of claim 1, wherein the movement sensing assembly is a touch detecting surface.

3. The electronic device of claim 1, wherein the movement sensing assembly is operable to detect a three-dimensional gestural password.

4. The electronic device of claim 1, wherein the password strength metric is computed by determining at least one of: a complexity metric, a size metric, a trace uniqueness metric, or a reliability metric corresponding to the proposed gestural password.

5. The electronic device of claim 4, wherein the signals are evaluated to determine one or more characteristics of the proposed gestural password including at least one of: a number of nodes of the proposed gestural password, a number of repeated nodes of the proposed gestural password, a number of edges of the proposed gestural password, a number of repeated edges of the proposed gestural password, or a number of gaps between edges of the proposed gestural password.

6. The electronic device of claim 5, wherein the complexity metric is computed taking into account at least one of the characteristics of the proposed gestural password.

7. The electronic device of claim 4, wherein the proposed gestural password is two-dimensional and the size metric is computed taking into account an area encompassed by the proposed gestural password.

8. The electronic device of claim 4, wherein the proposed gestural password is three-dimensional and the size metric is computed taking into account a volume encompassed by the proposed gestural password.

9. The electronic device of claim 4, wherein the trace uniqueness metric is computed by determining locations of nodes of the proposed gestural password and using a combinatorial search routine to determine a number of unique sequences which each encompass the nodes.

10. The electronic device of claim 4, wherein the password strength metric takes into account at least two of: the complexity metric, the size metric, the trace uniqueness metric, and the reliability metric.

11. The electronic device of claim 1, further wherein, if the password strength metric indicates that the proposed gestural password is below a predetermined strength in one or more respects, then the processor provides a recommendation regarding improving the strength of the proposed gestural password to the user output component.

12. The electronic device of claim 1, further wherein, if the password strength metric indicates that the proposed gestural password is below a predetermined strength in one or more respects, then the processor provides a recommendation to improve the strength of the proposed gestural password to the user output component, wherein the recommendation includes adding a recognition policy corresponding to a component gesture of the proposed gestural password, wherein the recognition policy to be added is selected from a group including: a match requirement and a non-match requirement.

13. The electronic device of claim 1, further wherein, if the password strength metric indicates that the proposed gestural password is below a first predetermined strength in one or more respects but above a second predetermined strength, then the processor provides a recommendation to improve the strength of the proposed gestural password to the user output component, wherein the recommendation includes adding a recognition policy corresponding to a component gesture of the proposed gestural password, wherein the recognition policy to be added is selected from a group including: a match requirement, an ignore requirement, and a match one of a set requirement.

14. The electronic device of claim 1, further wherein, if the password strength metric indicates that the proposed gestural password is below a first predetermined strength in one or more respects, then the processor provides a suggested gestural password improvement selected from: adding a tap gesture, adding a glide gesture, or adding a delay requirement between subsequent component gestures.

15. An electronic device comprising:
a touch detecting surface;
a user output component; and
a processor in electronic communication with the touch detecting surface programmed to detect a proposed gestural password applied thereto in conjunction with signals from the touch detecting surface, wherein the proposed gestural password is a sequence of glide gestures, and wherein the processor operates to evaluate a strength of the proposed gestural password in accordance with one or more password rules that take into account at least one of: a number of nodes of the proposed gestural password, a number of edges of the proposed gestural password, a number of gaps of the proposed gestural password, or a size of the proposed gestural password to provide a password strength metric which is indicative of the strength of the gestural password to the user output component.

16. The electronic device of claim 15, further wherein, if the password strength metric indicates that the proposed gestural password is below a predetermined strength in one or more respects, then the processor provides a recommendation regarding improving the strength of the proposed gestural password to the user output component, wherein the recommendation regarding improving the strength of the proposed gestural password includes at least one of: increasing the number of nodes of the proposed gestural password, decreasing the size of the proposed gestural password, increasing a uniqueness of the proposed gestural password, decreasing the number of gaps of the gestural password, or adding a recognition policy corresponding to each component gesture of the proposed gestural password.

17. The electronic device of claim 15, further wherein, if the password strength metric indicates that the proposed gestural password is below a predetermined strength in one or more respects, then the processor provides a recommendation to improve the strength of the proposed gestural password to the user output component, wherein the recommendation includes adding a recognition policy corresponding to a component gesture of the proposed gestural password, wherein the recognition policy to be added is selected from a group including: a match requirement, a non-match requirement, an ignore requirement, and a match one of a set requirement.

18. The electronic device of claim 15, further wherein, if the password strength metric indicates that the proposed gestural password is below a first predetermined strength in one or more respects, then the processor provides a suggested gestural password improvement of at least one of: an added tap gesture, an added glide gesture, or an added delay requirement between consecutive component gestures.

19. A method for analyzing a strength of a proposed gestural password, the method comprising:
detecting characteristics of the proposed gestural password that includes a sequence of component gestures;
analyzing the characteristics using a processor to compute a password strength metric indicative of the strength of the proposed gestural password; and
communicating an acceptability of the password strength metric to a user.

20. The method of claim 19, wherein the communicating comprises:
suggesting a gestural password improvement when the password strength metric is less than a predetermined threshold, wherein the suggested gestural password improvement includes: a tap gesture, a glide gesture, or a delay requirement between consecutive component gestures.

21. The method of claim 19, wherein the communicating comprises:
providing a recommendation to improve the strength of the proposed gestural password including adding a recognition policy corresponding to a component gesture of the proposed gestural password, wherein the recognition policy to be added is selected from a group including: a match requirement, a non-match requirement, an ignore requirement, and a match one of a set requirement.
